(19) United States
(12) Patent Application Publication
(10) Pub. No.: US 2007/0048417 A1
(43) Pub. Date: Mar. 1, 2007

(54) Method for preparing food article

(76) Inventor: LeRoy A. Parker JR., Castaic Lake, CA (US)

Correspondence Address: BUTZEL LONG, STONERIDGE WEST, 41000 WOODWARD AVENUE, BLOOMFIELD HILLS, MI, 48304, US

(21) Appl. No.: 10/553,678

(22) PCT Filed: Feb. 17, 2004
(86) PCT No.: PCT/US04/04622

§ 371 Date: Sep. 28, 2006

Related U.S. Application Data
(63) Continuation of application No. 10/373,109, filed on Feb. 26, 2003, now abandoned.
(60) Provisional application No. 60/359,311, filed on Feb. 26, 2002.

(51) Int. Cl. A21D 13/00

(52) U.S. Cl. 426/275

(57) ABSTRACT

A method for preparing meat products and a chip in a convenient and ready-to-eat form in a manner that is intended at preserving the meat flavor once part of the chip. The present invention provides an edible chip arrangement or similar foodstuff which includes a grain product such as wheat, rice or corn, as well as meat product sandwiched between at least two chips. The meat product can be a variety of types of meats, including, for example, pepperoni and beef jerky.

### TECHNICAL FIELD

The present invention relates to a method for preparing a food article in the form of a taco-style snack. More particularly, the present invention relates to a taco-style snack having two spaced-apart chips having a meat filling therebetween.

### DISCUSSION

Some time ago edible chips established themselves as a highly desirable snack food for between-meal consumption. Chips offer the convenience of being ready-to-eat and readily storable.

On the other hand, the use of meat and meat products is primarily known for consumption during main courses. Traditionally, meat and meat products, when served at all, are served either as a main dish or as a part of a sandwich or similar food combination. In some cases the meat or meat product may be combined with other components.

A variety of patents relate to food processing in this area. These include U.S. Pat. Nos. 3,512,993, 3,642,496, 3,865,955, and 6,083,554.

Each of these patents discloses an advancement in the use of a meat or a meat product in combination with another food to form a combined product. However, room is still available in the art for additional improvements in the form of a food article which includes meat or a meat product in a convenient, ready-to-eat form.

### SUMMARY OF THE INVENTION

The present invention is directed to the preparation of meat products and a chip in a convenient and ready-to-eat form, and in a manner that is intended at preserving the meat flavor once part of the chip. The present invention provides an edible chip arrangement or similar foodstuff which includes a grain product such as wheat, rice, or corn, as well as a meat product sandwiched between at least two chips. The meat product can be a variety of types of meats, including, for example, pepperoni and beef jerky.

Other objects and features of the present invention will become apparent as the description proceeds.

### BRIEF DESCRIPTION OF THE DRAWING

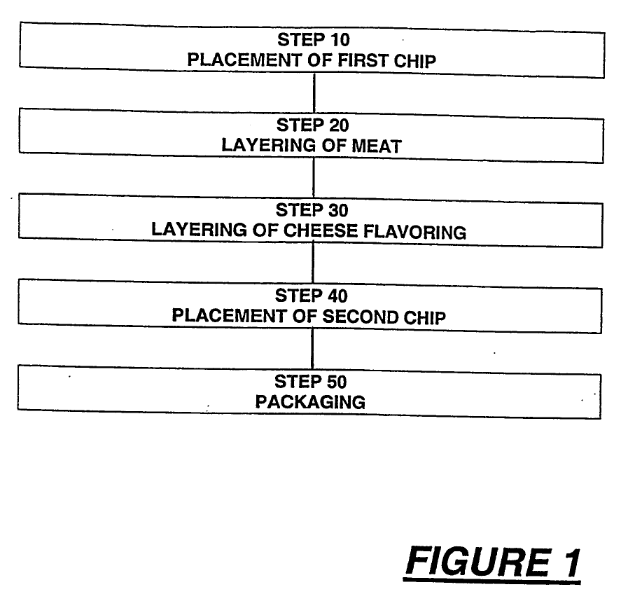

The present invention will be more fully understood by reference to the following detailed description of the preferred embodiments of the present invention when read in conjunction with the accompanying drawing, in which FIG. 1 is a flow diagram illustrating how the edible chip of the present invention may be prepared.

### DETAILED DESCRIPTION OF THE PREFERRED EMBODIMENTS

The drawing discloses the preferred embodiment for the production of the present edible chip invention. While the method of preparation according to the illustrated embodiment is preferred, it is envisioned that alternate methods of preparation of the present edible snack invention may be adopted without deviating from the invention as portrayed. The invention is best described by way of a specific example in which meat is used in the production of the snack.

At step 10, the first component, a squared or rounded corn chip (or another grain chip) of a thickness of between about 0.1 cm and 0.5 cm, is provided. The size of the chip, if square, is approximately 2.0 cm to 4.0 cm on all sides. Two chips—an “upper” chip and a “lower” chip—are used. The chips may be flavored as desired.

At step 20, a second component, between approximately 0.1 and 10. grams of soft jerky, is provided and is layered onto one of the two chips, this amount being enough to lay or spread across the corn chip. (A thin slice of jerky is about the thickness of a dime.) The jerky cannot be a thick bulky piece and should be along the lines of slice of meat on a sandwich. The jerky can be a processed beef spread or meat by-product, like turkey, chicken, or seafood. Whatever the choice, the meat must be soft enough to be able to be readily chewed.

At step 30, a third component, between approximately 0.1 and 10.0 grams of soft flavored cheese, is provided and is spread across the layer of meat. Different flavors and styles of cheese spread may be used, such as spicy, regular taco flavor, salsa and the like. Optionally, step 30 may be overlooked.

At step 40, the second chip is placed over the cheese-covered meat to form a sandwich-like cracker snack. The assembly is then pressed together so as not to fall apart. (Along these lines, and as a variation of the process described, the cheese layer may be placed on both sides of the meat layer.)

At step 50, the assembled snack is placed with other assembled snacks into a package, such as a double-stacked grouping wrapped in a clear plastic.

In addition to the above basic components, additional components may be included in the production of this food product according to the present invention. For example, and without limitation, flavorings such as cheeses and spices may be added as required for taste. In addition, and also without limitation, preservatives such as BHA, BHT, propyl gallate, and/or monoglyceride citrate may be added as required to preserve freshness. Colorings may also be added as required.

### EXAMPLE

According to an example of the present method, the following amounts of individual components were used to prepare a batch of the chip according to the present invention:

A. Chip

Ground grain meal: 350 ml

Salt: 10 ml

Water: 290 ml

Shortening: 10 ml

B. Jerky

25.0 g

C. Cheese

35.0 g

The method of the Example preparation is set forth above.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings and the specification.

What is claimed is:

1. A method of making a food product comprising the steps of:
(1) preparing a quantity of chips to form a first component by selecting an amount of grain product, an amount of salt, an amount of water, and an amount of a shortening, thereafter heating said shortening, and combining all of said grain product, said salt, said water, and said shortening to form a mixture, followed manipulating said mixture into plural pieces of selected shapes by first forming a ball then flattening said ball into a disc which is subsequently cut into the desired shapes for the chips;
(2) jerking a quantity of meat to form a second component;
(3) applying said quantity of jerked meat to a first chip;
(4) placing a second chip on top of said jerked meat.

2. The method of claim 1 further including the step of applying a selected amount of a cheese between said quantity of jerked meat and said second chip.

3. The method of claim 1 in which said quantity of jerked meat is between 0.1 g and 10.0 g.

4. The method of claim 2 in which said selected amount of cheese is between 0.1 g and 10.0 g.

5. The method of claim 1 in which said grain product is corn.

6. The method of claim 1 in which said meat is beef.

7. The method of claim 1 in which said shortening is vegetable shortening.

8. The method of claim 1 in which said chips are between 0.1 cm and 0.5 cm thick and are between 2.0 cm and 4.0 cm wide.

9. A method of making a food product comprising the steps of:
(1) providing a pair of chips having a thickness of between 0.1 cm and 0.5 cm and a width of between 2.0 cm and 4.0 cm;
(2) providing a meat component in the amount of between 0.1 g and 10.0 g and placing said meat component on one of said pair of chips;
(3) providing a cheese component in the amount of between 0.1 g and 10. G and placing said cheese component on top of said meat component; and
(4) placing the other of said pair of chips on said cheese component.

10. The method of claim 9 wherein said pair of chips are corn chips.

11. The method of claim 9 wherein said meat component is a jerked meat.

12. The method of claim 11 wherein said jerked meat is beef.
